(19) United States
(12) Patent Application Publication
(10) Pub. No.: US 2026/0289091 A1
(43) Pub. Date: Sep. 24, 2026

(54) MEETING VIDEO ANALYSIS AND SUMMARY GENERATION SYSTEM

(71) Applicant: SoftBank Group Corp., Tokyo (JP)

(72) Inventor: Hiyori YOSHIDA, Tokyo (JP)

(21) Appl. No.: 19/568,826

(22) Filed: Mar. 17, 2026

Related U.S. Application Data
(60) Provisional application No. 63/774,787, filed on Mar. 20, 2025.

(51) Int. Cl. G06F 40/166; G06F 40/268; G06F 40/35

(52) U.S. Cl. CPC G06F 40/166; G06F 40/268; G06F 40/35

(57) ABSTRACT

The present disclosure relates to a system that automatically extracts important information from a meeting video and generates a summary. A speech recognition unit extracts audio data from the video, and performs noise removal and speaker separation to convert it into text. A natural language processing unit performs morphological analysis, syntactic analysis, and semantic analysis on the text data to extract important keywords and phrases. A machine learning unit learns past meeting data and identifies important topics and key points of discussion. A summary generation unit creates a summary based on these key points and provides it in a format that a user can quickly understand. Furthermore, a video clip generation unit clips an important part of the video clip so that the user can directly watch it.

### CROSS-REFERENCE TO RELATED APPLICATION

This application claims the benefit of priority from U.S. Provisional Patent Application No. 63/774,787, filed on Mar. 20, 2025. The entire contents of the priority application are incorporated herein by reference.

### BACKGROUND

The technology of the present disclosure relates to a system.

Japanese Unexamined Patent Publication No. 2022-180282 discloses a method, which is a persona chatbot control method performed by at least one processor, the method including a step of receiving a user utterance, a step of adding the user utterance to a prompt including an instruction sentence associated with a description regarding a character of a chatbot, a step of encoding the prompt, and a step of inputting the encoded prompt to a language model to generate a chatbot utterance responding to the user utterance.

### SUMMARY

A problem to be solved by this disclosure is a significant reduction in time and effort in viewing meeting videos and creating meeting minutes. Conventionally, in order to grasp the content of a meeting, it was necessary to watch a long video and manually extract important information to create meeting minutes. This process is very time-consuming, and especially in organizations where meetings are frequent, the burden on participants becomes large. In addition, manual information extraction has a risk of overlooking important points, and the accuracy and consistency of information may be impaired.

Furthermore, when sharing the content of a meeting within a team, information transmission may be delayed, and this becomes a major obstacle in a business environment where prompt decision-making is required. Particularly, in the modern era where remote work and collaboration in global teams are increasing, efficient information sharing is becoming increasingly important.

This disclosure aims to solve these problems by automatically analyzing meeting videos and extracting important topics and key points of discussion. By combining speech recognition technology and natural language processing technology, necessary information is quickly and accurately extracted from a video to generate a summary. This process allows a user to quickly access necessary information without watching a long video. As a result, it is expected that time and effort will be saved, and communication and information sharing within a team will be facilitated.

As a means for solving this problem, a system is provided that includes a speech recognition unit, a natural language processing unit, a machine learning unit, and a summary generation unit. First, the speech recognition unit extracts audio data from a meeting video and converts the audio into text data using speech recognition technology. In this conversion process, preprocessing such as noise removal and speaker separation is performed to realize high-precision text conversion.

Next, the natural language processing unit performs morphological analysis, syntactic analysis, and semantic analysis on the generated text data. This makes it possible to extract important keywords and phrases in the text and identify highly relevant information by understanding the context.

Furthermore, the machine learning unit learns past meeting data and general meeting patterns, and identifies topics and key points of discussion of the meeting based on the extracted keywords and phrases. In this process, the machine learning unit analyzes appearance patterns of frequently occurring keywords and specific phrases to automatically identify highly important information.

Finally, the summary generation unit generates a summary based on the identified key points. This summary condenses the information necessary to grasp the overall picture of the meeting and is provided in a format that a user can quickly understand. This allows the user to quickly access necessary information without watching a long video, realizing a saving of time and effort. As a result, it is expected that communication and information sharing within a team will be facilitated.

### BRIEF DESCRIPTION OF DRAWINGS

FIG. 1 is a conceptual diagram illustrating an example of a configuration of a data processing system according to a first embodiment.

FIG. 2 is a conceptual diagram illustrating an example of main functions of a data processing apparatus and a smart device according to the first embodiment.

FIG. 3 is a conceptual diagram illustrating an example of a configuration of a data processing system according to a second embodiment.

FIG. 4 is a conceptual diagram illustrating an example of main functions of a data processing apparatus and smart glasses according to the second embodiment.

FIG. 5 is a conceptual diagram illustrating an example of a configuration of a data processing system according to a third embodiment.

FIG. 6 is a conceptual diagram illustrating an example of main functions of a data processing apparatus and a headset-type terminal according to the third embodiment.

FIG. 7 is a conceptual diagram illustrating an example of a configuration of a data processing system according to a fourth embodiment.

FIG. 8 is a conceptual diagram illustrating an example of main functions of a data processing apparatus and a robot according to the fourth embodiment.

FIG. 9 illustrates an emotion map on which a plurality of emotions are mapped.

FIG. 10 illustrates an emotion map on which a plurality of emotions are mapped.

FIG. 11 is a flowchart illustrating an example of a method for analyzing a meeting video and generating a summary.

### DETAILED DESCRIPTION

Hereinafter, an example of an embodiment of a system according to the technology of the present disclosure will be described with reference to the accompanying drawings.

First, terms used in the following description will be described.

In the following embodiments, a processor with a reference sign (hereinafter, simply referred to as a “processor”) may be one arithmetic device or may be a combination of a plurality of arithmetic devices. Also, the processor may be one type of arithmetic device or may be a combination of a plurality of types of arithmetic devices. Examples of the arithmetic device include a CPU (Central Processing Unit), a GPU (Graphics Processing Unit), a GPGPU (General-Purpose computing on Graphics Processing Units), an APU (Accelerated Processing Unit), and the like.

In the following embodiments, a RAM (Random Access Memory) with a reference sign is a memory in which information is temporarily stored, and is used as a work memory by a processor.

In the following embodiments, a storage with a reference sign is one or more non-volatile storage devices that store various programs, various parameters, and the like. Examples of the non-volatile storage device include a flash memory (SSD (Solid State Drive)), a magnetic disk (for example, a hard disk), or a magnetic tape, and the like.

In the following embodiments, a communication I/F (Interface) with a reference sign is an interface including a communication processor, an antenna, and the like. The communication I/F manages communication among a plurality of computers. An example of a communication standard applied to the communication I/F includes a wireless communication standard including 5G (5th Generation Mobile Communication System), Wi-Fi (registered trademark), or Bluetooth (registered trademark), and the like.

In the following embodiments, “A and/or B” is synonymous with “at least one of A and B”. That is, “A and/or B” means that it may be A only, B only, or a combination of A and B. Also, in the present specification, when three or more matters are expressed by being connected with “and/or”, the same concept as “A and/or B” is applied.

### First Embodiment

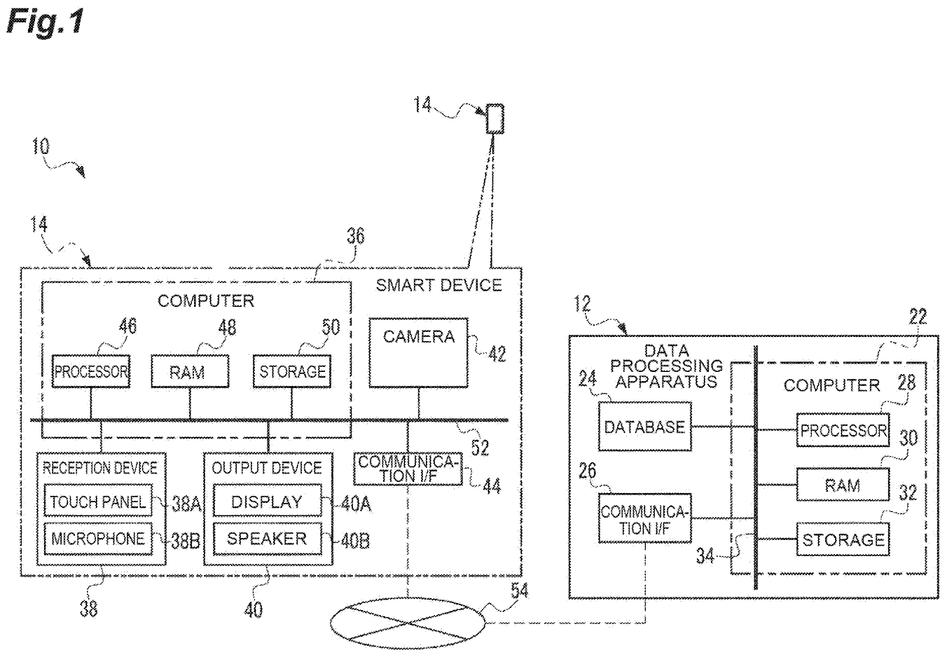

FIG. 1 illustrates an example of a configuration of a data processing system 10 according to a first embodiment.

As illustrated in FIG. 1, the data processing system 10 includes a data processing apparatus 12 and a smart device 14. An example of the data processing apparatus 12 includes a server.

The data processing apparatus 12 includes a computer 22, a database 24, and a communication I/F 26. The computer 22 is an example of a “computer” according to the technology of the present disclosure. The computer 22 includes a processor 28, a RAM 30, and a storage 32. The processor 28, the RAM 30, and the storage 32 are connected to a bus 34. Also, the database 24 and the communication I/F 26 are also connected to the bus 34. The communication I/F 26 is connected to a network 54. An example of the network 54 includes a WAN (Wide Area Network) and/or a LAN (Local Area Network), and the like.

The smart device 14 includes a computer 36, a reception device 38, an output device 40, a camera 42, and a communication I/F 44. The computer 36 includes a processor 46, a RAM 48, and a storage 50. The processor 46, the RAM 48, and the storage 50 are connected to a bus 52. Also, the reception device 38, the output device 40, and the camera 42 are also connected to the bus 52.

The reception device 38 includes a touch panel 38A, a microphone 38B, and the like, and receives a user input. The touch panel 38A receives a user input by contact of an indicator by detecting contact of the indicator (for example, a pen or a finger, etc.). The microphone 38B receives a user input by voice by detecting a user's voice. A control unit 46A transmits data indicating the user input received by the touch panel 38A and the microphone 38B to the data processing apparatus 12. In the data processing apparatus 12, a specific processing unit 290 acquires the data indicating the user input.

The output device 40 includes a display 40A, a speaker 40B, and the like, and presents data to a user 20 by outputting the data in a representation form (for example, voice and/or text) perceivable by the user 20. The display 40A displays visible information such as text and images in accordance with an instruction from the processor 46. The speaker 40B outputs voice in accordance with an instruction from the processor 46. The camera 42 is a small digital camera on which an optical system such as a lens, a diaphragm, and a shutter, and an image sensor such as a CMOS (Complementary Metal-Oxide-Semiconductor) image sensor or a CCD (Charge Coupled Device) image sensor are mounted.

The communication I/F 44 is connected to the network 54. The communication I/Fs 44 and 26 manage exchange of various information between the processor 46 and the processor 28 via the network 54.

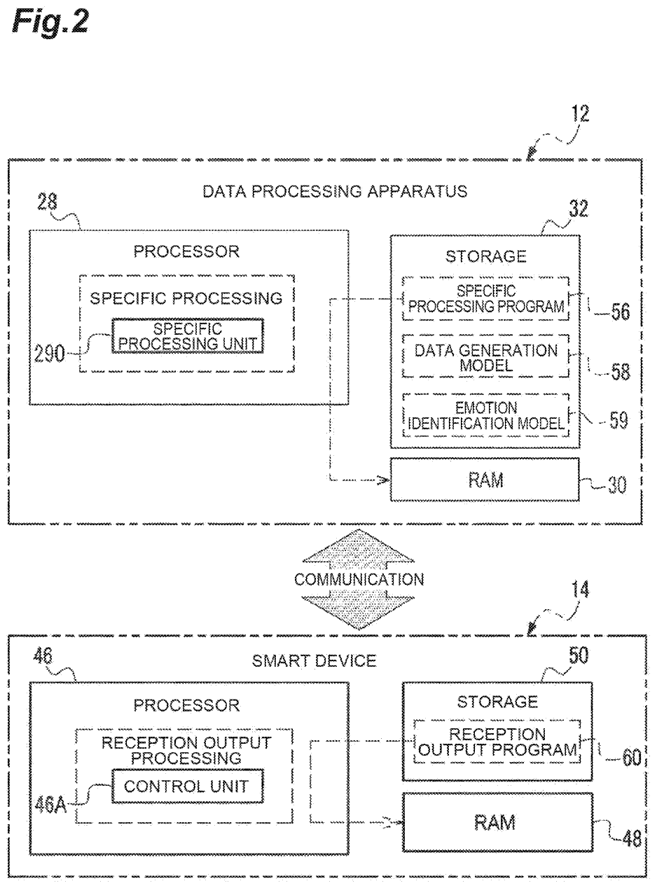

FIG. 2 illustrates an example of main functions of the data processing apparatus 12 and the smart device 14.

As illustrated in FIG. 2, in the data processing apparatus 12, specific processing is performed by the processor 28. A specific processing program 56 is stored in the storage 32. The specific processing program 56 is an example of a “program” according to the technology of the present disclosure. The processor 28 reads the specific processing program 56 from the storage 32 and executes the read specific processing program 56 on the RAM 30. The specific processing is realized by the processor 28 operating as a specific processing unit 290 in accordance with the specific processing program 56 executed on the RAM 30.

A data generation model 58 and an emotion identification model 59 are stored in the storage 32. The data generation model 58 and the emotion identification model 59 are used by the specific processing unit 290. The specific processing unit 290 can estimate a user's emotion using the emotion identification model 59 and perform specific processing using the user's emotion. In an emotion estimation function (emotion identification function) using the emotion identification model 59, various estimations and predictions regarding the user's emotion, including estimation and prediction of the user's emotion, are performed, but the present disclosure is not limited to such an example. Also, the estimation and prediction of emotion include, for example, analysis (analytics) of emotion and the like.

In the smart device 14, reception output processing is performed by the processor 46. A reception output program 60 is stored in the storage 50. The reception output program 60 is used in combination with the specific processing program 56 by the data processing system 10. The processor 46 reads the reception output program 60 from the storage 50 and executes the read reception output program 60 on the RAM 48. The specific processing is realized by the processor 46 operating as a control unit 46A in accordance with the specific processing program 60 executed on the RAM 48. Note that the smart device 14 can also have a data generation model and an emotion identification model similar to the data generation model 58 and the emotion identification model 59, and perform processing similar to that of the specific processing unit 290 using these models. The reception output processing is realized by the processor 46 operating as the control unit 46A in accordance with the reception output program 60 executed on the RAM 48.

Note that an apparatus other than the data processing apparatus 12 may have the data generation model 58. For example, a server apparatus (for example, a generation server) may have the data generation model 58. In this case, the data processing apparatus 12 obtains a processing result (such as a prediction result) in which the data generation model 58 is used, by communicating with the server apparatus having the data generation model 58. Also, the data processing apparatus 12 may be a server apparatus, or may be a terminal device owned by a user (for example, a mobile phone, a robot, a home appliance, etc.). Next, an example of processing by the data processing system 10 according to the first embodiment will be described.

### Example 1

A flow of specific processing in Example 1 will be described. Each unit of the system described below is realized by the data processing apparatus 12 and the smart device 14. Also, the data processing apparatus 12 is referred to as a “server”, and the smart device 14 is referred to as a “terminal”.

### Embodiment

As an embodiment, a case where a system that performs clipping of a meeting video and automatic extraction of a summary is realized by a server and a terminal will be described more specifically and in detail. This system realizes efficient information extraction and summary generation by the server and the terminal operating in cooperation, with each unit fulfilling its respective role.

First, a speech recognition unit is realized on the server. The speech recognition unit may be configured by, for example, the specific processing unit 290, the specific processing program 56, the data generation model 58, and the emotion identification model 59. When a meeting video is uploaded from a terminal to the server, the server extracts audio data from the video. This audio data is converted into text data by a speech recognition engine on the server. The speech recognition engine performs preprocessing such as noise removal and speaker separation to realize high-precision text conversion. For example, to remove environmental sounds in a conference room, the server uses advanced filtering technology to effectively eliminate the sound of air conditioners and external noise. In addition, even when there are multiple speakers, it is possible to accurately recognize individual utterances using speaker separation technology. This allows the content of the meeting to be accurately converted into text, and high accuracy can be maintained in subsequent processing.

Next, a natural language processing unit is also realized on the server. The natural language processing unit may be configured by, for example, the specific processing unit 290, the specific processing program 56, the data generation model 58, and the emotion identification model 59. The server performs morphological analysis, syntactic analysis, and semantic analysis on the text data generated by the speech recognition unit. In morphological analysis, the text is divided into word units, and the part of speech of each word is identified. In syntactic analysis, the structure of a sentence is analyzed to clarify relationships such as subject, predicate, and object. In semantic analysis, the semantic relevance between words is evaluated to understand the context. This makes it possible to extract important keywords and phrases in the text and identify highly relevant information by understanding the context. For example, it is possible to identify technical terms and project names frequently used during a meeting and grasp how they are being discussed. The server can also analyze the emotion and intent in the text using natural language processing technology to understand the nuance of an utterance.

Furthermore, a machine learning unit is also realized on the server. The machine learning unit may be configured by, for example, the specific processing unit 290, the specific processing program 56, the data generation model 58, and the emotion identification model 59. The machine learning unit identifies key points of the meeting using the extracted keywords as parameters via a machine learning model trained on past meeting data. The server learns past meeting data and general meeting patterns, and identifies topics and key points of discussion of the meeting based on the extracted keywords and phrases. In this process, the server analyzes appearance patterns of frequently occurring keywords and specific phrases to automatically identify highly important information (information with a relevance score above a predetermined threshold). For example, when a discussion about a specific project is held, important decisions and issues related to that project can be identified. The machine learning unit is provided with an algorithm for classifying the content of a meeting and prioritizing important topics. This allows a user to quickly grasp the overall picture of the meeting.

The natural language processing unit and the machine learning unit are specifically implemented using a neural network based on a Transformer architecture (for example, BERT, GPT, etc.). Here, tokenization processing is performed on the text data, and each token is mapped to a multidimensional vector space (Embedding Space). At this time, by using a Self-Attention mechanism, long-distance dependency relationships between words in a sentence are calculated, and weighting according to the context is performed. This enables accurate semantic analysis of utterances including “sarcasm” and “negation” dependent on context, which is impossible with mere keyword matching.

Also, when processing a long meeting video, the specific processing unit 290 divides the audio data into chunks for each predetermined time length (for example, 30 seconds), and performs memory management control to allocate each chunk to a GPU or NPU (Neural Processing Unit) capable of parallel processing. This significantly reduces calculation time compared to single-threaded processing, prevents overflow of the RAM 30, and optimizes resource consumption. This processing is executed at a speed and data volume that are practically impossible to perform in the human mind (Mental Process).

A summary generation unit is realized in a form in which a summary generated on the server is transmitted to the terminal. The summary generation unit may be configured by, for example, the specific processing unit 290, the specific processing program 56, the data generation model 58, the emotion identification model 59, and the communication I/F 26. The summary generation unit generates a summary based on the identified key points and provides it in a format that a user can quickly understand. The generated summary is transmitted to the terminal in a text file or PDF format so that the user can easily access it. For example, it is possible to provide a summary that condenses the information necessary to grasp the overall picture of the meeting and concisely shows important topics and conclusions. The summary generation unit is also provided with a function to adjust the level of detail of the summary according to the user's needs, and can provide information in various formats, from a short summary to a detailed report.

In addition, the system is provided with a function of clipping a video clip of an important part so that a user can directly watch it. In other words, the system is provided with a function of clipping a video segment corresponding to the identified key points from the video of the meeting and output the video segment. This allows the user to quickly access necessary information without watching a long video. For example, by providing a clip including highlights of a specific discussion or important statements, it is possible for the user to quickly grasp the main points of the meeting by watching it. The video clip can be customized to include a specific time range or utterances of a specific speaker according to the user's request.

In this way, by the server and the terminal operating in cooperation, efficient analysis and summary generation of a meeting video are realized, and a user can significantly save time and effort. As a result, it is expected that communication and information sharing within a team will be facilitated. This system will be an important tool that supports efficient information management and decision-making, especially in the modern era where remote work and collaboration in global teams are increasing.

The system according to the present embodiment may further include an evaluation unit and a warning unit that monitor the soundness of the meeting content. These evaluation unit and warning unit may be configured by, for example, the specific processing unit 290, the specific processing program 56, the data generation model 58, the emotion identification model 59, and the communication I/F 26.

In the evaluation unit, the extracted text data and the emotion data identified by the emotion identification model 59 are compared with a reference model constructed from past normal meeting data to calculate an anomaly score. For example, when an utterance including specific confidential information (“confidential”, “undisclosed”, etc.) and an emotion value indicating high “impatience” or “anxiety” are detected at the same time, the evaluation unit determines this as a “security risk”.

When the anomaly score exceeds a predetermined threshold, the warning unit immediately executes the following controls: (1) blocking of an external transmission port for meeting minutes and video data, (2) transmission of an encrypted alert notification to an administrator terminal, and (3) automatic generation of a video clip of the relevant part and transfer to a law enforcement agency or a compliance department by a dedicated protocol. This series of processing is executed in real time (for example, within a few milliseconds from the utterance) without human intervention, preventing information leakage.

### System Configuration

The system according to the present embodiment includes a speech recognition unit, a natural language processing unit, a machine learning unit, a summary generation unit, and a video clip generation unit. The speech recognition unit extracts audio data from a meeting video and converts the audio into text data using speech recognition technology. This unit performs preprocessing such as noise removal and speaker separation to realize high-precision text conversion. For example, to remove environmental sounds in a conference room, it uses advanced filtering technology to effectively eliminate the sound of air conditioners and external noise. In addition, even when there are multiple speakers, it is possible to accurately recognize individual utterances using speaker separation technology. Furthermore, the speech recognition unit is trained using an extensive audio dataset to accurately recognize the speech of speakers with different accents and dialects. In addition, the speech recognition unit enables real-time speech recognition and can perform text conversion instantly during a meeting.

The natural language processing unit performs morphological analysis, syntactic analysis, and semantic analysis on the text data generated by the speech recognition unit. This unit extracts important keywords and phrases in the text and identifies highly relevant information by understanding the context. For example, in morphological analysis, the text is divided into word units, and the part of speech of each word is identified. In syntactic analysis, the structure of a sentence is analyzed to clarify relationships such as subject, predicate, and object. In semantic analysis, the semantic relevance between words is evaluated to understand the context. Furthermore, the natural language processing unit can also analyze the emotion and intent in the text to understand the nuance of an utterance. It can also perform analysis with high accuracy even for text containing technical terms and industry-specific terms.

The machine learning unit learns past meeting data and general meeting patterns, and identifies topics and key points of discussion of the meeting based on the extracted keywords and phrases. This unit analyzes appearance patterns of frequently occurring keywords and specific phrases to automatically identify highly important information. For example, when a discussion about a specific project is held, important decisions and issues related to that project can be identified. The machine learning unit is provided with an algorithm for classifying the content of a meeting and prioritizing important topics. The machine learning unit can also continuously improve the model based on user feedback to enhance accuracy. Furthermore, it can learn meeting data in different industries and fields to support a wide range of applications.

The summary generation unit generates a summary based on the identified key points and provides it in a format that a user can quickly understand. This unit transmits the generated summary to a terminal in a text file or PDF format so that the user can easily access it. For example, it can provide a summary that condenses the information necessary to grasp the overall picture of the meeting and concisely shows important topics and conclusions. The summary generation unit is also provided with a function to adjust the level of detail of the summary according to the user's needs, and can provide information in various formats, from a short summary to a detailed report. Furthermore, the summary generation unit also supports summary generation in different languages, and supports use in international teams.

The video clip generation unit clips a video clip of an important part so that a user can directly watch it. This unit allows the user to quickly access necessary information without watching a long video. For example, by providing a clip including highlights of a specific discussion or important statements, it is possible for the user to quickly grasp the main points of the meeting by watching it. The video clip generation unit can customize the clip to include a specific time range or utterances of a specific speaker according to the user's request. The video clip can also be output in different resolutions and formats, and supports viewing on various devices.

Specific examples of prompt sentences to be read into a generative AI necessary for carrying out the present disclosure include “Extract the main points of this meeting and summarize the important topics,” “Identify discussions related to a specific project and identify related decisions,” and “Generate a video clip containing important statements during the meeting.” By using these prompt sentences, the system can efficiently perform information extraction and summary generation according to the user's needs.

### Implementation Steps

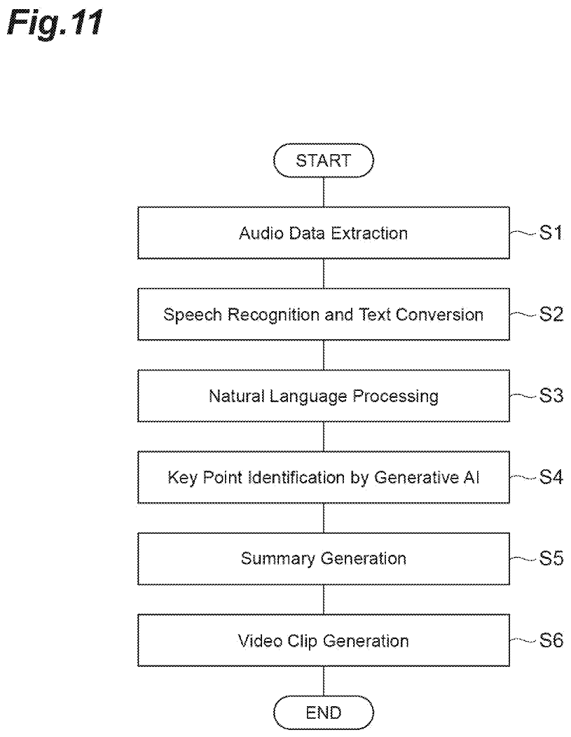

### Step 1: Audio Data Extraction (See Step S1 in FIG. 11)

When a meeting video is uploaded from a terminal to a server, a speech recognition unit extracts audio data from the video. In this step, the audio part of the video is separated to prepare for subsequent speech recognition processing. The extraction of audio data uses different methods depending on the format of the video, but generally, the audio track is directly extracted, or the entire video is analyzed to separate the audio part.

### Step 2: Speech Recognition and Text Conversion (See Step S2 in FIG. 11)

The extracted audio data is converted into text data by a speech recognition engine on the server. In this step, preprocessing such as noise removal and speaker separation is performed to realize high-precision text conversion. For example, it is possible to remove environmental sounds in a conference room and accurately recognize individual utterances even when there are multiple speakers. The speech recognition engine is trained using an extensive audio dataset to accurately recognize the speech of speakers with different accents and dialects.

### Step 3: Natural Language Processing (See Step S3 in FIG. 11)

A natural language processing unit performs morphological analysis, syntactic analysis, and semantic analysis on the text data generated by the speech recognition unit. In this step, important keywords and phrases in the text are extracted, and highly relevant information is identified by understanding the context. For example, in morphological analysis, the text is divided into word units, and the part of speech of each word is identified. In syntactic analysis, the structure of a sentence is analyzed to clarify relationships such as subject, predicate, and object. In semantic analysis, the semantic relevance between words is evaluated to understand the context.

### Step 4: Key Point Identification by Generative AI (See Step S4 in FIG. 11)

A machine learning unit learns past meeting data and general meeting patterns, and identifies topics and key points of discussion of the meeting based on the extracted keywords and phrases. In this step, a generative AI is used to automatically identify important information. Specific examples of prompt sentences to be read into the generative AI include “Extract the main points of this meeting and summarize the important topics,” and “Identify discussions related to a specific project and identify related decisions.”

### Step 5: Summary Generation (See Step S5 in FIG. 11)

A summary generation unit generates a summary based on the identified key points and provides it in a format that a user can quickly understand. In this step, the generated summary is transmitted to a terminal in a text file or PDF format so that the user can easily access it. For example, it is possible to provide a summary that condenses the information necessary to grasp the overall picture of the meeting and concisely shows important topics and conclusions. The summary generation unit is also provided with a function to adjust the level of detail of the summary according to the user's needs.

### Step 6: Video Clip Generation (See Step S6 in FIG. 11)

A video clip generation unit clips a video clip of an important part so that a user can directly watch it. This step allows the user to quickly access necessary information without watching a long video. For example, by providing a clip including highlights of a specific discussion or important statements, it is possible for the user to quickly grasp the main points of the meeting by watching it. The video clip can be customized to include a specific time range or utterances of a specific speaker according to the user's request.

### Specific Use Case

For example, consider a case where a company conducting an international project holds regular online meetings with teams located in multiple locations. In such an environment, members at each location are in different time zones, and it is often difficult for everyone to participate in the meeting in real time. For this reason, a system is required that can accurately record the content of the meeting and allow the main points to be easily grasped later.

The system of the present disclosure, by uploading a meeting video to a server, allows a speech recognition unit to extract audio data and convert it to text. The speech recognition unit performs noise removal and speaker separation to realize high-precision text conversion. For example, it is possible to remove environmental sounds in a conference room and accurately recognize individual utterances even when there are multiple speakers.

Next, a natural language processing unit performs morphological analysis, syntactic analysis, and semantic analysis on the text data to extract important keywords and phrases. This process makes it possible to identify technical terms and project names frequently used during the meeting and grasp how they are being discussed.

A machine learning unit learns past meeting data and general meeting patterns, and identifies topics and key points of discussion of the meeting based on the extracted information. For example, when a discussion about a specific project is held, important decisions and issues related to that project can be identified.

A summary generation unit generates a summary based on the identified key points and provides it in a format that a user can quickly understand. The generated summary is provided in a text file or PDF format so that the user can easily access it. For example, it is possible to provide a summary that condenses the information necessary to grasp the overall picture of the meeting and concisely shows important topics and conclusions.

A video clip generation unit clips a video clip of an important part so that a user can directly watch it. This allows the user to quickly access necessary information without watching a long video. For example, by providing a clip including highlights of a specific discussion or important statements, it is possible for the user to quickly grasp the main points of the meeting by watching it.

Specific examples of prompt sentences to be read into a generative AI necessary for carrying out the present disclosure include “Extract the main points of this meeting and summarize the important topics,” “Identify discussions related to a specific project and identify related decisions,” and “Generate a video clip containing important statements during the meeting.” By using these prompt sentences, the system can efficiently perform information extraction and summary generation according to the user's needs.

### Application Example 1

A flow of specific processing in Application Example 1 will be described. Each unit of the system described below is realized by the data processing apparatus 12 and the smart device 14. Also, the data processing apparatus 12 is referred to as a “server”, and the smart device 14 is referred to as a “terminal”.

### Embodiment

As an embodiment, a system for improving the efficiency of care meetings held in a nursing care facility will be described in detail. This system includes a speech recognition unit, a natural language processing unit, a machine learning unit, a summary generation unit, and a video clip generation unit, and by each unit operating in cooperation, the content of a meeting is efficiently analyzed and the main points are extracted.

First, the speech recognition unit extracts audio data from a video of a care meeting held in a nursing care facility. In this process, a video recorded using a dedicated camera or recording device is uploaded to a server. The speech recognition unit performs noise removal and speaker separation to realize high-precision text conversion. For example, it is possible to effectively remove air conditioning noise and external noise within the facility, and to accurately recognize each utterance even when multiple staff members speak at the same time. The speech recognition unit is also trained using an extensive audio dataset to accurately recognize the speech of speakers with different accents and dialects. Furthermore, it enables real-time speech recognition and can perform text conversion instantly during a meeting. For example, when an urgent care plan change is necessary, the content can be instantly converted to text and quickly shared with the relevant parties.

Next, the natural language processing unit performs morphological analysis, syntactic analysis, and semantic analysis on the text data generated by the speech recognition unit. In this process, important keywords and phrases in the text are extracted, and highly relevant information is identified by understanding the context. For example, it is possible to identify important information in care, such as a patient's name, medical condition, and changes to a care plan. The natural language processing unit can perform analysis with high accuracy even for text containing technical terms and medical terms. It is also possible to analyze the emotion and intent in the text to understand the nuance of an utterance. For example, if there is a difference of opinion among staff, the underlying intent and emotion can be analyzed to propose an appropriate solution.

The machine learning unit learns past care meeting data and identifies topics and key points of discussion of the meeting based on the extracted information. In this process, appearance patterns of frequently occurring keywords and specific phrases are analyzed to automatically identify highly important information. For example, when a change in a care plan for a specific patient or a new care policy is discussed, the content is identified so that staff can respond quickly. The machine learning unit can continuously improve the model based on user feedback to enhance accuracy. Furthermore, it can learn meeting data in different industries and fields to support a wide range of applications. For example, it can learn from success stories at other nursing care facilities and apply them to its own facility's care plans.

The summary generation unit generates a summary based on the identified key points and provides it in a format that care staff can quickly understand. The generated summary is provided in a text file or PDF format so that staff can easily access it. For example, it is possible to provide a summary that condenses the information necessary to grasp the overall picture of the meeting and concisely shows important topics and conclusions. The summary generation unit is provided with a function to adjust the level of detail of the summary according to the user's needs, and can provide information in various formats, from a short summary to a detailed report. It also supports summary generation in different languages, and supports use in international teams. For example, in an international nursing care facility where multilingual support is required, it is useful for staff from each country to have a common understanding.

The video clip generation unit clips a video clip of an important part so that a user can directly watch it. This unit allows the user to quickly access necessary information without watching a long video. For example, by providing a clip including highlights of a specific discussion or important statements, it is possible for the user to quickly grasp the main points of the meeting by watching it. The video clip can be customized to include a specific time range or utterances of a specific speaker according to the user's request. The video clip can also be output in different resolutions and formats, and supports viewing on various devices. For example, viewing on a smartphone or tablet is possible, which supports prompt decision-making on site.

In this way, by each unit operating in cooperation, efficient analysis and summary generation of care meetings in a nursing care facility are realized, and care staff can significantly save time and effort. As a result, an improvement in the quality of care and a reduction in the burden on staff are expected. This system will be an important tool that supports efficient information management and decision-making, especially in the modern era where remote work and collaboration in global teams are increasing.

### System Configuration

The system according to the present embodiment includes a speech recognition unit, a natural language processing unit, a machine learning unit, a summary generation unit, and a video clip generation unit. The speech recognition unit extracts audio data from a video of a care meeting held in a nursing care facility, and performs noise removal and speaker separation to realize high-precision text conversion. This unit can effectively remove air conditioning noise and external noise within the facility, and accurately recognize each utterance even when multiple staff members speak at the same time. For example, by filtering environmental sounds in a conference room and eliminating the sound of air conditioners and external noise, clear audio data is acquired. The speech recognition unit is also trained using an extensive audio dataset to accurately recognize the speech of speakers with different accents and dialects. Furthermore, it enables real-time speech recognition and can perform text conversion instantly during a meeting. For example, when an urgent care plan change is necessary, the content can be instantly converted to text and quickly shared with the relevant parties.

The natural language processing unit performs morphological analysis, syntactic analysis, and semantic analysis on the text data generated by the speech recognition unit. This unit extracts important keywords and phrases in the text and identifies highly relevant information by understanding the context. For example, it is possible to identify important information in care, such as a patient's name, medical condition, and changes to a care plan. The natural language processing unit can perform analysis with high accuracy even for text containing technical terms and medical terms. It is also possible to analyze the emotion and intent in the text to understand the nuance of an utterance. For example, if there is a difference of opinion among staff, the underlying intent and emotion can be analyzed to propose an appropriate solution.

The machine learning unit learns past care meeting data and identifies topics and key points of discussion of the meeting based on the extracted information. This unit analyzes appearance patterns of frequently occurring keywords and specific phrases to automatically identify highly important information. For example, when a change in a care plan for a specific patient or a new care policy is discussed, the content is identified so that staff can respond quickly. The machine learning unit can continuously improve the model based on user feedback to enhance accuracy. Furthermore, it can learn meeting data in different industries and fields to support a wide range of applications. For example, it can learn from success stories at other nursing care facilities and apply them to its own facility's care plans.

The summary generation unit generates a summary based on the identified key points and provides it in a format that care staff can quickly understand. This unit provides the generated summary in a text file or PDF format so that staff can easily access it. For example, it is possible to provide a summary that condenses the information necessary to grasp the overall picture of the meeting and concisely shows important topics and conclusions. The summary generation unit is provided with a function to adjust the level of detail of the summary according to the user's needs, and can provide information in various formats, from a short summary to a detailed report. It also supports summary generation in different languages, and supports use in international teams. For example, in an international nursing care facility where multilingual support is required, it is useful for staff from each country to have a common understanding.

The video clip generation unit clips a video clip of an important part so that a user can directly watch it. This unit allows the user to quickly access necessary information without watching a long video. For example, by providing a clip including highlights of a specific discussion or important statements, it is possible for the user to quickly grasp the main points of the meeting by watching it. The video clip can be customized to include a specific time range or utterances of a specific speaker according to the user's request. The video clip can also be output in different resolutions and formats, and supports viewing on various devices. For example, viewing on a smartphone or tablet is possible, which supports prompt decision-making on site.

Specific examples of prompt sentences to be read into a generative AI necessary for carrying out the present disclosure include “Extract the main points of this care meeting and summarize the important care plan changes,” “Identify discussions related to a specific patient and identify the related care policies,” and “Generate a video clip containing important statements during the meeting.” By using these prompt sentences, the system can efficiently perform information extraction and summary generation according to the needs of the care site.

### Implementation Steps

### Step 1: Audio Data Extraction

A video of a care meeting held in a nursing care facility is recorded using a dedicated camera or recording device and uploaded to a server. The speech recognition unit extracts audio data from the video and performs noise removal and speaker separation. For example, it is possible to effectively remove air conditioning noise and external noise within the facility, and to accurately recognize each utterance even when multiple staff members speak at the same time. It is trained using an extensive audio dataset to accurately recognize the speech of speakers with different accents and dialects.

### Step 2: Text Conversion and Analysis

The audio data generated by the speech recognition unit is converted into text data. The natural language processing unit performs morphological analysis, syntactic analysis, and semantic analysis on this text data. For example, it is possible to identify important information in care, such as a patient's name, medical condition, and changes to a care plan. It can perform analysis with high accuracy even for text containing technical terms and medical terms.

### Step 3: Key Point Identification and Utilization of Generative AI

The machine learning unit learns past care meeting data and identifies topics and key points of discussion of the meeting based on the extracted information. In this step, a generative AI is used to automatically identify important information. Specific examples of prompt sentences to be read into the generative AI include “Extract the main points of this care meeting and summarize the important care plan changes,” and “Identify discussions related to a specific patient and identify the related care policies.”

### Step 4: Summary Generation

The summary generation unit generates a summary based on the identified key points and provides it in a format that care staff can quickly understand. The generated summary is provided in a text file or PDF format so that staff can easily access it. For example, it is possible to provide a summary that condenses the information necessary to grasp the overall picture of the meeting and concisely shows important topics and conclusions.

### Step 5: Video Clip Generation

The video clip generation unit clips a video clip of an important part so that a user can directly watch it. It allows the user to quickly access necessary information without watching a long video. For example, by providing a clip including highlights of a specific discussion or important statements, it is possible for the user to quickly grasp the main points of the meeting by watching it. The video clip can be customized to include a specific time range or utterances of a specific speaker according to the user's request.

### Specific Use Case

For example, in a certain nursing care facility, there is a regularly held care meeting. In this meeting, the progress of each patient's care plan and proposals for new care policies are discussed. The staff in the facility are busy, and it is difficult for everyone to participate in the meeting, so it is necessary to efficiently share the content of the meeting. This system, by uploading a recording of the meeting to a server, allows a speech recognition unit to extract audio data, and perform noise removal and speaker separation to convert it to text. For example, it is possible to remove air conditioning noise and external noise within the facility, and to accurately recognize each utterance even when multiple staff members speak at the same time.

Next, a natural language processing unit performs morphological analysis, syntactic analysis, and semantic analysis on the text data to extract important keywords and phrases. For example, it is possible to identify important information in care, such as a patient's name, medical condition, and changes to a care plan. A machine learning unit learns past care meeting data and identifies topics and key points of discussion of the meeting based on the extracted information. For example, when a change in a care plan for a specific patient or a new care policy is discussed, the content is identified so that staff can respond quickly.

A summary generation unit generates a summary based on the identified key points and provides it in a format that care staff can quickly understand. The generated summary is provided in a text file or PDF format so that staff can easily access it. For example, it is possible to provide a summary that condenses the information necessary to grasp the overall picture of the meeting and concisely shows important topics and conclusions. A video clip generation unit clips a video clip of an important part so that a user can directly watch it. For example, by providing a clip including highlights of a specific discussion or important statements, it is possible for the user to quickly grasp the main points of the meeting by watching it.

Specific examples of prompt sentences to be read into a generative AI necessary for carrying out the present disclosure include “Extract the main points of this care meeting and summarize the important care plan changes,” “Identify discussions related to a specific patient and identify the related care policies,” and “Generate a video clip containing important statements during the meeting.” By using these prompt sentences, the system can efficiently perform information extraction and summary generation according to the needs of the care site.

The specific processing unit 290 transmits a result of the specific processing to the smart device 14. In the smart device 14, the control unit 46A causes the output device 40 to output the result of the specific processing. The microphone 38B acquires voice indicating a user input for the result of the specific processing. The control unit 46A transmits voice data indicating the user input acquired by the microphone 38B to the data processing apparatus 12. In the data processing apparatus 12, the specific processing unit 290 acquires the voice data.

The data generation model 58 is a so-called generative AI (Artificial Intelligence). An example of the data generation model 58 includes a generative AI such as ChatGPT (registered trademark) (Internet search <URL: https://openai.com/blog/chatgpt>). The data generation model 58 is obtained by causing a neural network to perform deep learning. A prompt including an instruction is input to the data generation model 58, and inference data such as voice data indicating voice, text data indicating text, and image data indicating an image (for example, still image data or moving image data) is input. The data generation model 58 infers the input inference data in accordance with the instruction indicated by the prompt, and outputs an inference result in one or more data formats among voice data, text data, image data, and the like. The data generation model 58 includes, for example, a text generation AI, an image generation AI, a multimodal generation AI, and the like. Here, inference refers to, for example, analysis, classification, prediction, and/or summarization, and the like. The specific processing unit 290 performs the above-described specific processing while using the data generation model 58. The data generation model 58 may be a model fine-tuned to output an inference result from a prompt that does not include an instruction, and in this case, the data generation model 58 can output an inference result from a prompt that does not include an instruction. In the data processing apparatus 12 and the like, a plurality of types of data generation models 58 are included, and the data generation model 58 includes AIs other than generative AI. AIs other than generative AI are, for example, linear regression, logistic regression, a decision tree, a random forest, a support vector machine (SVM), k-means clustering, a convolutional neural network (CNN), a recurrent neural network (RNN), a generative adversarial network (GAN), or naive Bayes, and can perform various processes, but the present disclosure is not limited to such examples. Also, the AI may be an AI agent. Also, when the processing of each unit described above is performed by an AI, the processing is partially or entirely performed by the AI, but the present disclosure is not limited to such an example. Also, a process implemented by an AI including a generative AI may be replaced with a rule-based process, and a rule-based process may be replaced with a process implemented by an AI including a generative AI.

Also, the processing by the data processing system 10 described above is executed by the specific processing unit 290 of the data processing apparatus 12 or the control unit 46A of the smart device 14, but may also be executed by the specific processing unit 290 of the data processing apparatus 12 and the control unit 46A of the smart device 14. Also, the specific processing unit 290 of the data processing apparatus 12 acquires or collects information necessary for the processing from the smart device 14 or an external device, and the smart device 14 acquires or collects information necessary for the processing from the data processing apparatus 12 or an external device.

For example, a collection unit is realized by the control unit 46A of the smart device 14 or the specific processing unit 290 of the data processing apparatus 12. For example, an acquisition unit acquires step count data using the camera 42 or the communication I/F 44 of the smart device 14, and the data is processed by the specific processing unit 290 of the data processing apparatus 12. For example, an analysis unit is realized by the specific processing unit 290 of the data processing apparatus 12, and analyzes data from the collection unit and the acquisition unit. For example, a generation unit is realized by the specific processing unit 290 of the data processing apparatus 12, and generates a cooking menu using a generative AI. For example, a provision unit is realized by the output device 40 of the smart device 14 or the specific processing unit 290 of the data processing apparatus 12, and provides the generated cooking menu to a user. The correspondence relationship between each unit and the device or the control unit is not limited to the above-described example, and various changes are possible.

In the above embodiment, an example form in which the specific processing is performed by the data processing apparatus 12 has been described, but the technology of the present disclosure is not limited to this, and the specific processing may be performed by the smart device 14.

### Second Embodiment

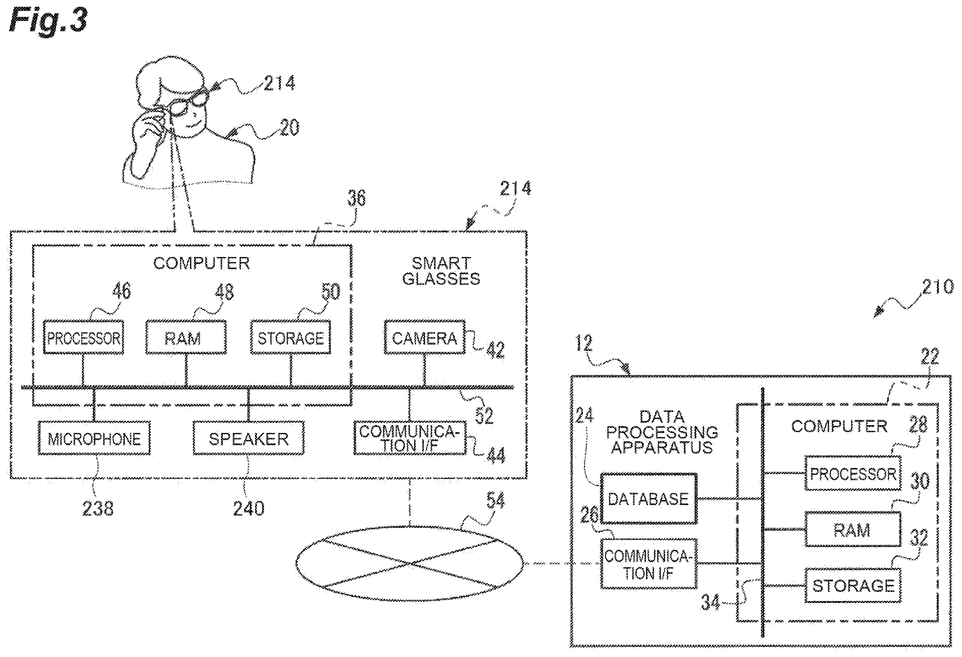

FIG. 3 illustrates an example of a configuration of a data processing system 210 according to a second embodiment.

As illustrated in FIG. 3, the data processing system 210 includes a data processing apparatus 12 and smart glasses 214. An example of the data processing apparatus 12 includes a server.

The data processing apparatus 12 includes a computer 22, a database 24, and a communication I/F 26. The computer 22 is an example of a “computer” according to the technology of the present disclosure. The computer 22 includes a processor 28, a RAM 30, and a storage 32. The processor 28, the RAM 30, and the storage 32 are connected to a bus 34. Also, the database 24 and the communication I/F 26 are also connected to the bus 34. The communication I/F 26 is connected to a network 54. An example of the network 54 includes a WAN (Wide Area Network) and/or a LAN (Local Area Network), and the like.

The smart glasses 214 include a computer 36, a microphone 238, a speaker 240, a camera 42, and a communication I/F 44. The computer 36 includes a processor 46, a RAM 48, and a storage 50. The processor 46, the RAM 48, and the storage 50 are connected to a bus 52. Also, the microphone 238, the speaker 240, and the camera 42 are also connected to the bus 52.

The microphone 238 receives an instruction or the like from a user 20 by receiving voice uttered by the user 20. The microphone 238 captures the voice uttered by the user 20, converts the captured voice into voice data, and outputs the voice data to the processor 46. The speaker 240 outputs voice in accordance with an instruction from the processor 46.

The camera 42 is a small digital camera on which an optical system such as a lens, a diaphragm, and a shutter, and an image sensor such as a CMOS (Complementary Metal-Oxide-Semiconductor) image sensor or a CCD (Charge Coupled Device) image sensor are mounted, and images the surroundings of the user 20 (for example, an imaging range defined by an angle of view corresponding to the width of the field of view of a general person with normal vision).

The communication I/F 44 is connected to the network 54. The communication I/Fs 44 and 26 manage exchange of various information between the processor 46 and the processor 28 via the network 54. The exchange of various information between the processor 46 and the processor 28 using the communication I/Fs 44 and 26 is performed in a secure state.

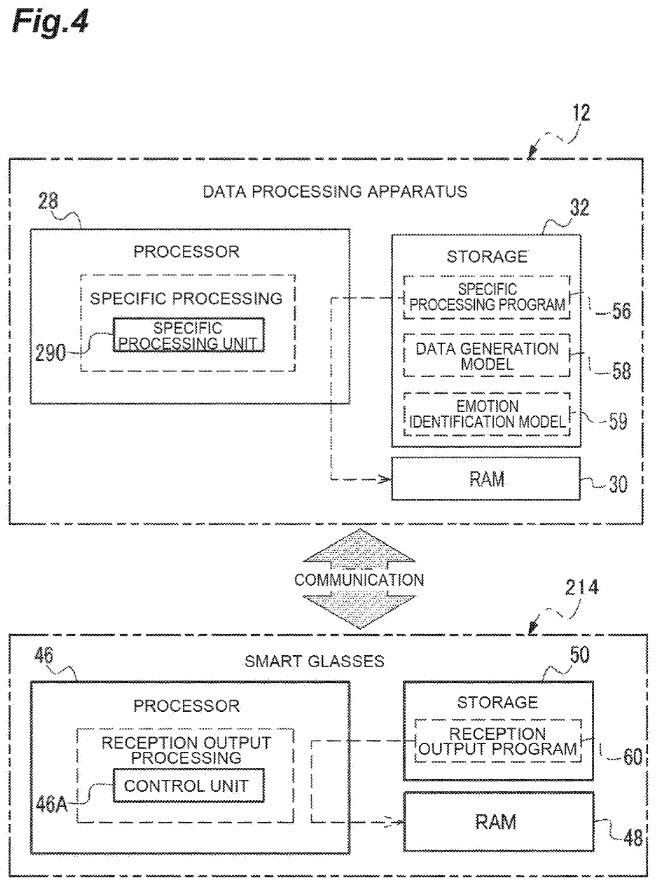

FIG. 4 illustrates an example of main functions of the data processing apparatus 12 and the smart glasses 214. As illustrated in FIG. 4, in the data processing apparatus 12, specific processing is performed by the processor 28. A specific processing program 56 is stored in the storage 32.

The specific processing program 56 is an example of a “program” according to the technology of the present disclosure. The processor 28 reads the specific processing program 56 from the storage 32 and executes the read specific processing program 56 on the RAM 30. The specific processing is realized by the processor 28 operating as a specific processing unit 290 in accordance with the specific processing program 56 executed on the RAM 30.

A data generation model 58 and an emotion identification model 59 are stored in the storage 32. The data generation model 58 and the emotion identification model 59 are used by the specific processing unit 290. The specific processing unit 290 can estimate a user's emotion using the emotion identification model 59 and perform specific processing using the user's emotion. In an emotion estimation function (emotion identification function) using the emotion identification model 59, various estimations and predictions regarding the user's emotion, including estimation and prediction of the user's emotion, are performed, but the present disclosure is not limited to such an example. Also, the estimation and prediction of emotion include, for example, analysis (analytics) of emotion and the like.

In the smart glasses 214, reception output processing is performed by the processor 46. A reception output program 60 is stored in the storage 50. The processor 46 reads the reception output program 60 from the storage 50 and executes the read reception output program 60 on the RAM 48. The reception output processing is realized by the processor 46 operating as a control unit 46A in accordance with the reception output program 60 executed on the RAM 48. Note that the smart glasses 214 can also have a data generation model and an emotion identification model similar to the data generation model 58 and the emotion identification model 59, and perform processing similar to that of the specific processing unit 290 using these models.

Next, specific processing by the specific processing unit 290 of the data processing apparatus 12 will be described. Each unit of the system described below is realized by the data processing apparatus 12 and the smart glasses 214. In the following description, the data processing apparatus 12 is referred to as a “server”, and the smart glasses 214 are referred to as a “terminal”.

### Example 1

Since the flow of the specific processing is the same as that in Example 1 described in the first embodiment, a description thereof is omitted.

### Application Example 1

Since the flow of the specific processing is the same as that in Example 1 described in the first embodiment, a description thereof is omitted.

The specific processing unit 290 transmits a result of the specific processing to the smart glasses 214. In the smart glasses 214, the control unit 46A causes the speaker 240 to output the result of the specific processing. The microphone 238 acquires voice indicating a user input for the result of the specific processing. The control unit 46A transmits voice data indicating the user input acquired by the microphone 238 to the data processing apparatus 12. In the data processing apparatus 12, the specific processing unit 290 acquires the voice data.

The data generation model 58 is a so-called generative AI (Artificial Intelligence). An example of the data generation model 58 includes a generative AI such as ChatGPT (registered trademark) (Internet search <URL: https://openai.com/blog/chatgpt>). The data generation model 58 is obtained by causing a neural network to perform deep learning. A prompt including an instruction is input to the data generation model 58, and inference data such as voice data indicating voice, text data indicating text, and image data indicating an image (for example, still image data or moving image data) is input. The data generation model 58 infers the input inference data in accordance with the instruction indicated by the prompt, and outputs an inference result in one or more data formats among voice data, text data, image data, and the like. The data generation model 58 includes, for example, a text generation AI, an image generation AI, a multimodal generation AI, and the like. Here, inference refers to, for example, analysis, classification, prediction, and/or summarization, and the like. The specific processing unit 290 performs the above-described specific processing while using the data generation model 58. The data generation model 58 may be a model fine-tuned to output an inference result from a prompt that does not include an instruction, and in this case, the data generation model 58 can output an inference result from a prompt that does not include an instruction. In the data processing apparatus 12 and the like, a plurality of types of data generation models 58 are included, and the data generation model 58 includes AIs other than generative AI. AIs other than generative AI are, for example, linear regression, logistic regression, a decision tree, a random forest, a support vector machine (SVM), k-means clustering, a convolutional neural network (CNN), a recurrent neural network (RNN), a generative adversarial network (GAN), or naive Bayes, and can perform various processes, but the present disclosure is not limited to such examples. Also, the AI may be an AI agent. Also, when the processing of each unit described above is performed by an AI, the processing is partially or entirely performed by the AI, but the present disclosure is not limited to such an example. Also, a process implemented by an AI including a generative AI may be replaced with a rule-based process, and a rule-based process may be replaced with a process implemented by an AI including a generative AI.

Also, the processing by the data processing system 10 described above is executed by the specific processing unit 290 of the data processing apparatus 12 or the control unit 46A of the smart device 14, but may also be executed by the specific processing unit 290 of the data processing apparatus 12 and the control unit 46A of the smart device 14. Also, the specific processing unit 290 of the data processing apparatus 12 acquires or collects information necessary for the processing from the smart device 14 or an external device, and the smart device 14 acquires or collects information necessary for the processing from the data processing apparatus 12 or an external device.

For example, a collection unit is realized by the control unit 46A of the smart device 14 or the specific processing unit 290 of the data processing apparatus 12. For example, an acquisition unit acquires step count data using the camera 42 or the communication I/F 44 of the smart device 14, and the data is processed by the specific processing unit 290 of the data processing apparatus 12. For example, an analysis unit is realized by the specific processing unit 290 of the data processing apparatus 12, and analyzes data from the collection unit and the acquisition unit. For example, a generation unit is realized by the specific processing unit 290 of the data processing apparatus 12, and generates a cooking menu using a generative AI. For example, a provision unit is realized by the output device 40 of the smart device 14 or the specific processing unit 290 of the data processing apparatus 12, and provides the generated cooking menu to a user. The correspondence relationship between each unit and the device or the control unit is not limited to the above-described example, and various changes are possible.

In the above embodiment, an example form in which the specific processing is performed by the data processing apparatus 12 has been described, but the technology of the present disclosure is not limited to this, and the specific processing may be performed by the smart glasses 214.

### Third Embodiment

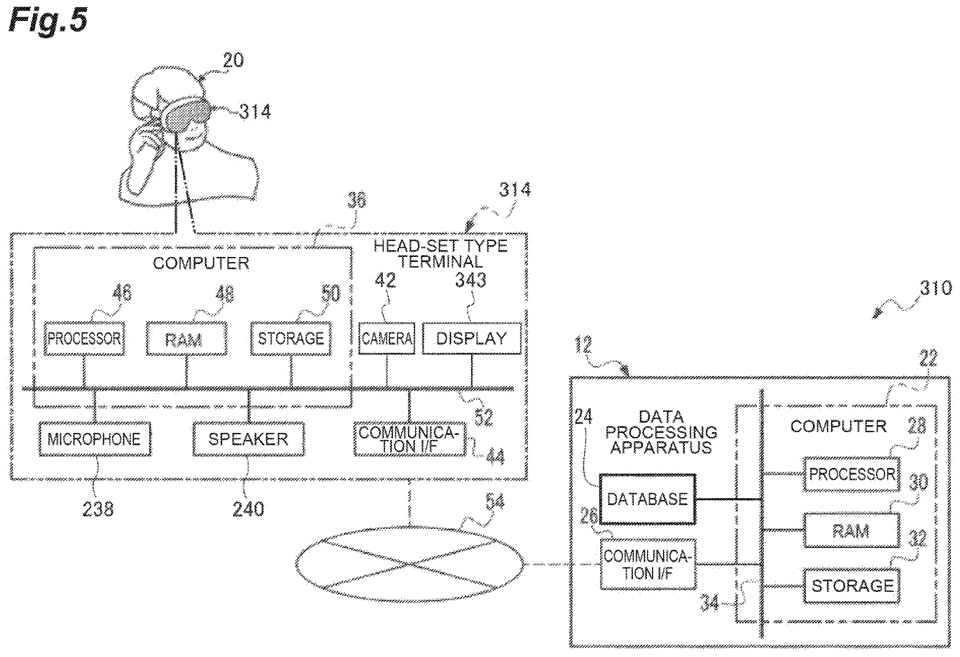

FIG. 5 illustrates an example of a configuration of a data processing system 310 according to a third embodiment.

As illustrated in FIG. 5, the data processing system 310 includes a data processing apparatus 12 and a headset-type terminal 314. An example of the data processing apparatus 12 includes a server.

The data processing apparatus 12 includes a computer 22, a database 24, and a communication I/F 26. The computer 22 is an example of a “computer” according to the technology of the present disclosure. The computer 22 includes a processor 28, a RAM 30, and a storage 32. The processor 28, the RAM 30, and the storage 32 are connected to a bus 34. Also, the database 24 and the communication I/F 26 are also connected to the bus 34. The communication I/F 26 is connected to a network 54. An example of the network 54 includes a WAN (Wide Area Network) and/or a LAN (Local Area Network), and the like.

The headset-type terminal 314 includes a computer 36, a microphone 238, a speaker 240, a camera 42, a communication I/F 44, and a display 343. The computer 36 includes a processor 46, a RAM 48, and a storage 50. The processor 46, the RAM 48, and the storage 50 are connected to a bus 52. Also, the microphone 238, the speaker 240, the camera 42, and the display 343 are also connected to the bus 52.

The microphone 238 receives an instruction or the like from a user 20 by receiving voice uttered by the user 20. The microphone 238 captures the voice uttered by the user 20, converts the captured voice into voice data, and outputs the voice data to the processor 46. The speaker 240 outputs voice in accordance with an instruction from the processor 46.

The camera 42 is a small digital camera on which an optical system such as a lens, a diaphragm, and a shutter, and an image sensor such as a CMOS (Complementary Metal-Oxide-Semiconductor) image sensor or a CCD (Charge Coupled Device) image sensor are mounted, and images the surroundings of the user 20 (for example, an imaging range defined by an angle of view corresponding to the width of the field of view of a general person with normal vision).

The communication I/F 44 is connected to the network 54. The communication I/Fs 44 and 26 manage exchange of various information between the processor 46 and the processor 28 via the network 54. The exchange of various information between the processor 46 and the processor 28 using the communication I/Fs 44 and 26 is performed in a secure state.

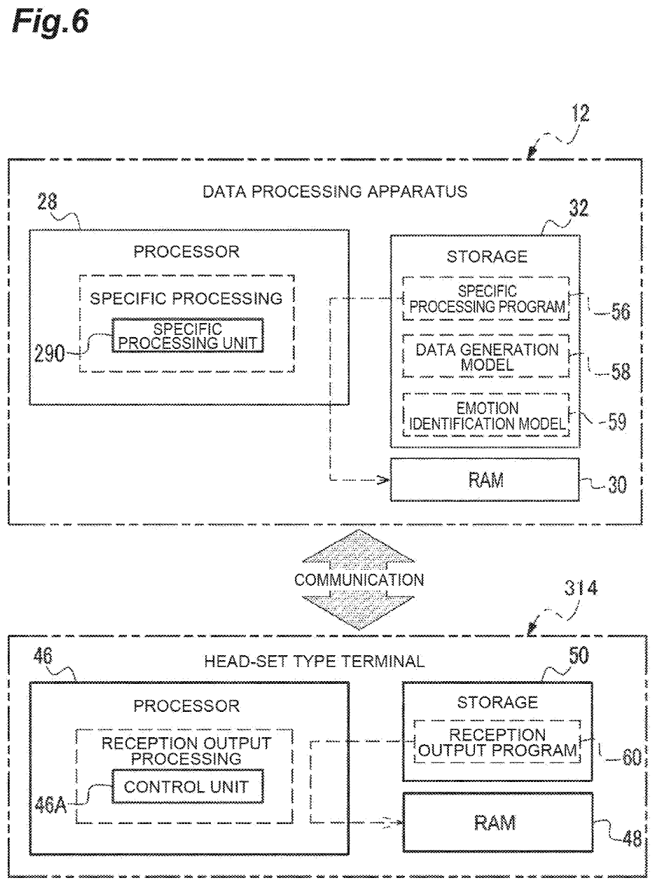

FIG. 6 illustrates an example of main functions of the data processing apparatus 12 and the headset-type terminal 314. As illustrated in FIG. 6, in the data processing apparatus 12, specific processing is performed by the processor 28. A specific processing program 56 is stored in the storage 32.

The specific processing program 56 is an example of a “program” according to the technology of the present disclosure. The processor 28 reads the specific processing program 56 from the storage 32 and executes the read specific processing program 56 on the RAM 30. The specific processing is realized by the processor 28 operating as a specific processing unit 290 in accordance with the specific processing program 56 executed on the RAM 30.

A data generation model 58 and an emotion identification model 59 are stored in the storage 32. The data generation model 58 and the emotion identification model 59 are used by the specific processing unit 290.

In the headset-type terminal 314, reception output processing is performed by the processor 46. A reception output program 60 is stored in the storage 50. The processor 46 reads the reception output program 60 from the storage 50 and executes the read reception output program 60 on the RAM 48. The reception output processing is realized by the processor 46 operating as a control unit 46A in accordance with the reception output program 60 executed on the RAM 48.

Next, specific processing by the specific processing unit 290 of the data processing apparatus 12 will be described. Each unit of the system described below is realized by the data processing apparatus 12 and the headset-type terminal 314. In the following description, the data processing apparatus 12 is referred to as a “server”, and the headset-type terminal 314 is referred to as a “terminal”.

### Example 1

Since the flow of the specific processing is the same as that in Example 1 described in the first embodiment, a description thereof is omitted.

### Application Example 1

Since the flow of the specific processing is the same as that in Example 1 described in the first embodiment, a description thereof is omitted.

The specific processing unit 290 transmits a result of the specific processing to the headset-type terminal 314. In the headset-type terminal 314, the control unit 46A causes the speaker 240 and the display 343 to output the result of the specific processing. The microphone 238 acquires voice indicating a user input for the result of the specific processing. The control unit 46A transmits voice data indicating the user input acquired by the microphone 238 to the data processing apparatus 12. In the data processing apparatus 12, the specific processing unit 290 acquires the voice data.

The data generation model 58 is a so-called generative AI (Artificial Intelligence). An example of the data generation model 58 includes a generative AI such as ChatGPT (registered trademark) (Internet search <URL: https://openai.com/blog/chatgpt>). The data generation model 58 is obtained by causing a neural network to perform deep learning. A prompt including an instruction is input to the data generation model 58, and inference data such as voice data indicating voice, text data indicating text, and image data indicating an image (for example, still image data or moving image data) is input. The data generation model 58 infers the input inference data in accordance with the instruction indicated by the prompt, and outputs an inference result in one or more data formats among voice data, text data, image data, and the like. The data generation model 58 includes, for example, a text generation AI, an image generation AI, a multimodal generation AI, and the like. Here, inference refers to, for example, analysis, classification, prediction, and/or summarization, and the like. The specific processing unit 290 performs the above-described specific processing while using the data generation model 58. The data generation model 58 may be a model fine-tuned to output an inference result from a prompt that does not include an instruction, and in this case, the data generation model 58 can output an inference result from a prompt that does not include an instruction. In the data processing apparatus 12 and the like, a plurality of types of data generation models 58 are included, and the data generation model 58 includes AIs other than generative AI. AIs other than generative AI are, for example, linear regression, logistic regression, a decision tree, a random forest, a support vector machine (SVM), k-means clustering, a convolutional neural network (CNN), a recurrent neural network (RNN), a generative adversarial network (GAN), or naive Bayes, and can perform various processes, but the present disclosure is not limited to such examples. Also, the AI may be an AI agent. Also, when the processing of each unit described above is performed by an AI, the processing is partially or entirely performed by the AI, but the present disclosure is not limited to such an example. Also, a process implemented by an AI including a generative AI may be replaced with a rule-based process, and a rule-based process may be replaced with a process implemented by an AI including a generative AI.

Also, the processing by the data processing system 10 described above is executed by the specific processing unit 290 of the data processing apparatus 12 or the control unit 46A of the smart device 14, but may also be executed by the specific processing unit 290 of the data processing apparatus 12 and the control unit 46A of the smart device 14. Also, the specific processing unit 290 of the data processing apparatus 12 acquires or collects information necessary for the processing from the smart device 14 or an external device, and the smart device 14 acquires or collects information necessary for the processing from the data processing apparatus 12 or an external device.

For example, a collection unit is realized by the control unit 46A of the smart device 14 or the specific processing unit 290 of the data processing apparatus 12. For example, an acquisition unit acquires step count data using the camera 42 or the communication I/F 44 of the smart device 14, and the data is processed by the specific processing unit 290 of the data processing apparatus 12. For example, an analysis unit is realized by the specific processing unit 290 of the data processing apparatus 12, and analyzes data from the collection unit and the acquisition unit. For example, a generation unit is realized by the specific processing unit 290 of the data processing apparatus 12, and generates a cooking menu using a generative AI. For example, a provision unit is realized by the output device 40 of the smart device 14 or the specific processing unit 290 of the data processing apparatus 12, and provides the generated cooking menu to a user. The correspondence relationship between each unit and the device or the control unit is not limited to the above-described example, and various changes are possible.

In the above embodiment, an example form in which the specific processing is performed by the data processing apparatus 12 has been described, but the technology of the present disclosure is not limited to this, and the specific processing may be performed by the headset-type terminal 314.

### Fourth Embodiment

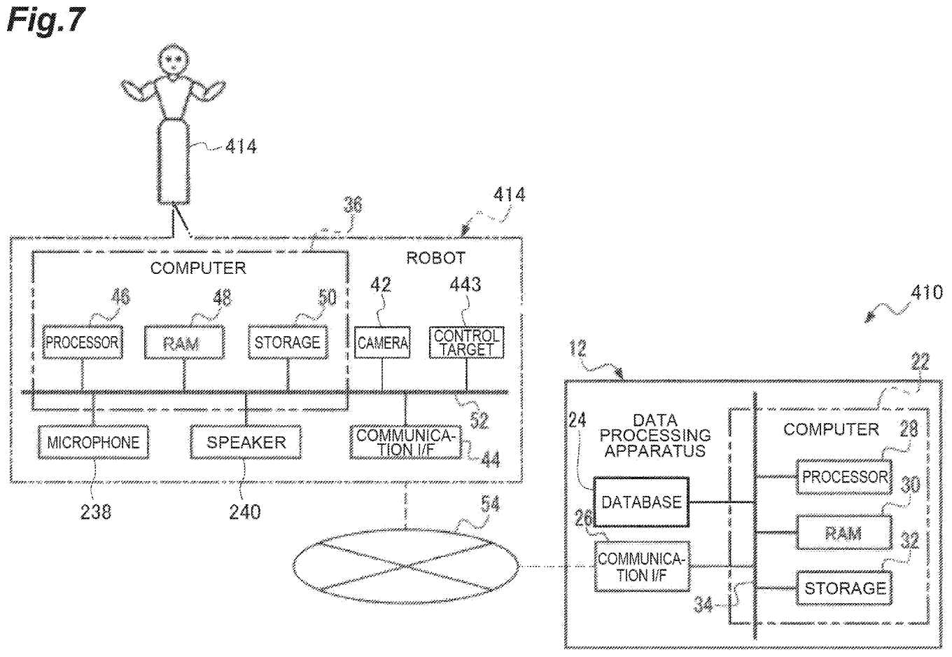

FIG. 7 illustrates an example of a configuration of a data processing system 410 according to a fourth embodiment.

As illustrated in FIG. 7, the data processing system 410 includes a data processing apparatus 12 and a robot 414. An example of the data processing apparatus 12 includes a server.

The data processing apparatus 12 includes a computer 22, a database 24, and a communication I/F 26. The computer 22 is an example of a “computer” according to the technology of the present disclosure. The computer 22 includes a processor 28, a RAM 30, and a storage 32. The processor 28, the RAM 30, and the storage 32 are connected to a bus 34. Also, the database 24 and the communication I/F 26 are also connected to the bus 34. The communication I/F 26 is connected to a network 54. An example of the network 54 includes a WAN (Wide Area Network) and/or a LAN (Local Area Network), and the like.

The robot 414 includes a computer 36, a microphone 238, a speaker 240, a camera 42, a communication I/F 44, and a control target 443. The computer 36 includes a processor 46, a RAM 48, and a storage 50. The processor 46, the RAM 48, and the storage 50 are connected to a bus 52. Also, the microphone 238, the speaker 240, the camera 42, and the control target 443 are also connected to the bus 52.

The microphone 238 receives an instruction or the like from a user 20 by receiving voice uttered by the user 20. The microphone 238 captures the voice uttered by the user 20, converts the captured voice into voice data, and outputs the voice data to the processor 46. The speaker 240 outputs voice in accordance with an instruction from the processor 46.

The camera 42 is a small digital camera on which an optical system such as a lens, a diaphragm, and a shutter, and an image sensor such as a CMOS (Complementary Metal-Oxide-Semiconductor) image sensor or a CCD (Charge Coupled Device) image sensor are mounted, and images the surroundings of the user 20 (for example, an imaging range defined by an angle of view corresponding to the width of the field of view of a general person with normal vision).

The communication I/F 44 is connected to the network 54. The communication I/Fs 44 and 26 manage exchange of various information between the processor 46 and the processor 28 via the network 54. The exchange of various information between the processor 46 and the processor 28 using the communication I/Fs 44 and 26 is performed in a secure state.

The control target 443 includes a display device, an LED of an eye part, and motors that drive an arm, a hand, a leg, and the like. The posture and gestures of the robot 414 are controlled by controlling the motors of the arm, hand, leg, and the like. A part of the emotions of the robot 414 can be expressed by controlling these motors. Also, the facial expression of the robot 414 can also be expressed by controlling the light emission state of the LED of the eye part of the robot 414.

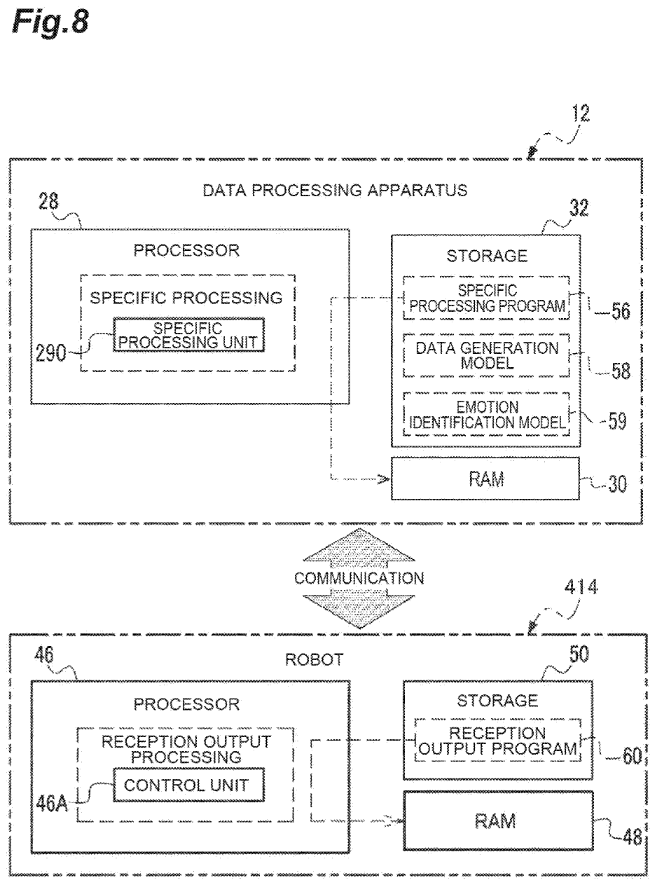

FIG. 8 illustrates an example of main functions of the data processing apparatus 12 and the robot 414. As illustrated in FIG. 8, in the data processing apparatus 12, specific processing is performed by the processor 28. A specific processing program 56 is stored in the storage 32.

The specific processing program 56 is an example of a “program” according to the technology of the present disclosure. The processor 28 reads the specific processing program 56 from the storage 32 and executes the read specific processing program 56 on the RAM 30. The specific processing is realized by the processor 28 operating as a specific processing unit 290 in accordance with the specific processing program 56 executed on the RAM 30.

A data generation model 58 and an emotion identification model 59 are stored in the storage 32. The data generation model 58 and the emotion identification model 59 are used by the specific processing unit 290.

In the robot 414, reception output processing is performed by the processor 46. A reception output program 60 is stored in the storage 50. The processor 46 reads the reception output program 60 from the storage 50 and executes the read reception output program 60 on the RAM 48. The reception output processing is realized by the processor 46 operating as a control unit 46A in accordance with the reception output program 60 executed on the RAM 48.

Next, specific processing by the specific processing unit 290 of the data processing apparatus 12 will be described. Each unit of the system described below is realized by the data processing apparatus 12 and the robot 414. In the following description, the data processing apparatus 12 is referred to as a “server”, and the robot 414 is referred to as a “terminal”.

### Example 1

Since the flow of the specific processing is the same as that in Example 1 described in the first embodiment, a description thereof is omitted.

### Application Example 1

Since the flow of the specific processing is the same as that in Example 1 described in the first embodiment, a description thereof is omitted.

The specific processing unit 290 transmits a result of the specific processing to the robot 414. In the robot 414, the control unit 46A causes the speaker 240 and the control target 443 to output the result of the specific processing. The microphone 238 acquires voice indicating a user input for the result of the specific processing. The control unit 46A transmits voice data indicating the user input acquired by the microphone 238 to the data processing apparatus 12. In the data processing apparatus 12, the specific processing unit 290 acquires the voice data.

The data generation model 58 is a so-called generative AI (Artificial Intelligence). An example of the data generation model 58 includes a generative AI such as ChatGPT (registered trademark) (Internet search <URL: https://openai.com/blog/chatgpt>). The data generation model 58 is obtained by causing a neural network to perform deep learning. A prompt including an instruction is input to the data generation model 58, and inference data such as voice data indicating voice, text data indicating text, and image data indicating an image (for example, still image data or moving image data) is input. The data generation model 58 infers the input inference data in accordance with the instruction indicated by the prompt, and outputs an inference result in one or more data formats among voice data, text data, image data, and the like. The data generation model 58 includes, for example, a text generation AI, an image generation AI, a multimodal generation AI, and the like. Here, inference refers to, for example, analysis, classification, prediction, and/or summarization, and the like. The specific processing unit 290 performs the above-described specific processing while using the data generation model 58. The data generation model 58 may be a model fine-tuned to output an inference result from a prompt that does not include an instruction, and in this case, the data generation model 58 can output an inference result from a prompt that does not include an instruction. In the data processing apparatus 12 and the like, a plurality of types of data generation models 58 are included, and the data generation model 58 includes AIs other than generative AI. AIs other than generative AI are, for example, linear regression, logistic regression, a decision tree, a random forest, a support vector machine (SVM), k-means clustering, a convolutional neural network (CNN), a recurrent neural network (RNN), a generative adversarial network (GAN), or naive Bayes, and can perform various processes, but the present disclosure is not limited to such examples. Also, the AI may be an AI agent. Also, when the processing of each unit described above is performed by an AI, the processing is partially or entirely performed by the AI, but the present disclosure is not limited to such an example. Also, a process implemented by an AI including a generative AI may be replaced with a rule-based process, and a rule-based process may be replaced with a process implemented by an AI including a generative AI.

Also, the processing by the data processing system 10 described above is executed by the specific processing unit 290 of the data processing apparatus 12 or the control unit 46A of the smart device 14, but may also be executed by the specific processing unit 290 of the data processing apparatus 12 and the control unit 46A of the smart device 14. Also, the specific processing unit 290 of the data processing apparatus 12 acquires or collects information necessary for the processing from the smart device 14 or an external device, and the smart device 14 acquires or collects information necessary for the processing from the data processing apparatus 12 or an external device.

For example, a collection unit is realized by the control unit 46A of the smart device 14 or the specific processing unit 290 of the data processing apparatus 12. For example, an acquisition unit acquires step count data using the camera 42 or the communication I/F 44 of the smart device 14, and the data is processed by the specific processing unit 290 of the data processing apparatus 12. For example, an analysis unit is realized by the specific processing unit 290 of the data processing apparatus 12, and analyzes data from the collection unit and the acquisition unit. For example, a generation unit is realized by the specific processing unit 290 of the data processing apparatus 12, and generates a cooking menu using a generative AI. For example, a provision unit is realized by the output device 40 of the smart device 14 or the specific processing unit 290 of the data processing apparatus 12, and provides the generated cooking menu to a user. The correspondence relationship between each unit and the device or the control unit is not limited to the above-described example, and various changes are possible.

In the above embodiment, an example form in which the specific processing is performed by the data processing apparatus 12 has been described, but the technology of the present disclosure is not limited to this, and the specific processing may be performed by the robot 414.

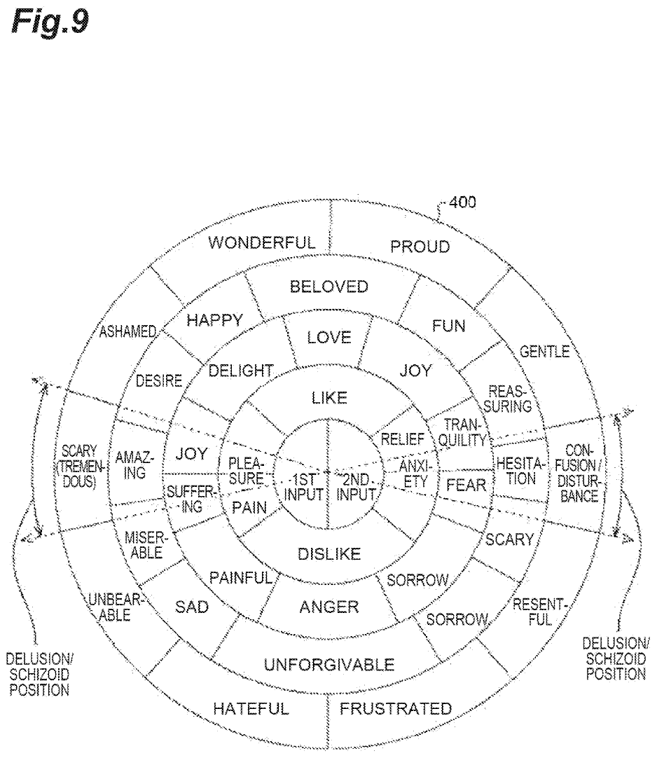

Note that the emotion identification model 59 as an emotion engine may determine a user's emotion according to a specific mapping. Specifically, the emotion identification model 59 may determine the user's emotion according to an emotion map (see FIG. 9), which is a specific mapping. Also, the emotion identification model 59 may similarly determine the robot's emotion, and the specific processing unit 290 may perform specific processing using the robot's emotion.

FIG. 9 is a diagram illustrating an emotion map 400 on which a plurality of emotions are mapped. In the emotion map 400, emotions are arranged in concentric circles radiating from the center. The closer to the center of the concentric circles, the more primitive the state of the emotion is arranged. On the outer side of the concentric circles, emotions representing states and actions arising from a state of mind are arranged. Emotion is a concept that also includes affect and mental states. On the left side of the concentric circles, emotions generated from reactions that generally occur in the brain are arranged. On the right side of the concentric circles, emotions that are generally induced by situational judgment are arranged. In the upward and downward directions of the concentric circles, emotions that are generated from reactions that generally occur in the brain and are induced by situational judgment are arranged. Also, on the upper side of the concentric circles, “pleasant” emotions are arranged, and on the lower side, “unpleasant” emotions are arranged. In this way, in the emotion map 400, a plurality of emotions are mapped based on the structure in which emotions are generated, and emotions that are likely to occur at the same time are mapped close to each other.

These emotions are distributed in the 3 o'clock direction of the emotion map 400, and usually go back and forth between relief and anxiety. In the right half of the emotion map 400, situational awareness is superior to internal sensations, resulting in a calm impression.

Since the inside of the emotion map 400 represents the inside of the mind and the outside of the emotion map 400 represents actions, the further one goes to the outside of the emotion map 400, the more visible (manifested in action) the emotion becomes.

Here, human emotions are based on various balances such as posture and blood sugar levels, and show a state of unpleasantness when those balances move away from the ideal, and a state of pleasantness when they approach the ideal. In robots, automobiles, motorcycles, and the like as well, emotions can be created based on various balances such as posture and remaining battery level, so as to show a state of unpleasantness when those balances move away from the ideal, and a state of pleasantness when they approach the ideal. The emotion map may be generated based on, for example, Dr. Mitsuyoshi's emotion map (Research on a speech emotion recognition and brain physiological signal analysis system of affect, Tokushima University, doctoral dissertation: https://ci.nii.ac.jp/naid/500000375379). In the left half of the emotion map, emotions belonging to a region called “reaction” where sensation is dominant are arranged. Also, in the right half of the emotion map, emotions belonging to a region called “situation” where situational awareness is dominant are arranged.

In the emotion map, two emotions that promote learning are defined. One is an emotion around the middle of negative “remorse” and “reflection” on the situation side. That is, it is when a negative emotion such as “I never want to feel this way again” or “I don't want to be scolded anymore” arises in the robot. The other is an emotion around positive “desire” on the reaction side. That is, it is when there is a positive feeling such as “I want more” or “I want to know more”.

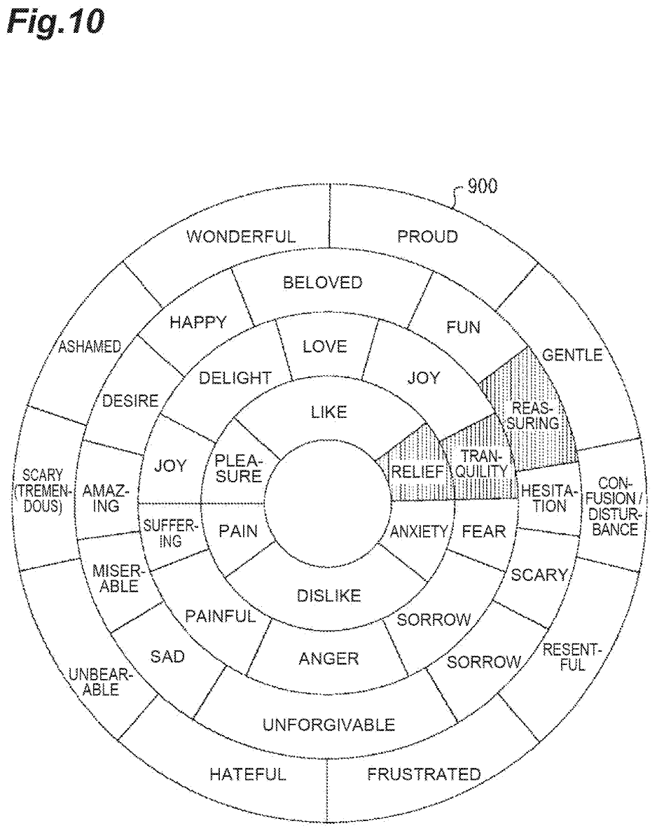

The emotion identification model 59 inputs a user input into a pre-trained neural network, acquires an emotion value indicating each emotion shown in the emotion map 400, and determines the user's emotion. This neural network is pre-trained based on a plurality of learning data that are combinations of user inputs and emotion values indicating each emotion shown in the emotion map 400. Also, this neural network is trained such that emotions arranged close to each other have close values, as in the emotion map 900 shown in FIG. 10. FIG. 10 shows an example in which a plurality of emotions, “relief,” “peace of mind,” and “reassured,” have close emotion values.

The determination of emotion by the emotion identification model 59 is performed by vector calculation using coordinates (angle θ and radius r) on the emotion map 400. Specifically, the pitch, tone, and speed of the user's voice and the semantic content of the text are used as input vectors, and the probability of belonging to each emotion region (class) on the emotion map is calculated using a softmax function or the like. Thereby, a complex emotional state in which, for example, “anger” and “sadness” are mixed is quantified as a continuous numerical parameter instead of a single label, and is directly converted into a control parameter (motor drive speed or LED color temperature) of the robot 414.

Although the system according to the present disclosure has been described above mainly with respect to the functions of the data processing apparatus 12, the system according to the present disclosure is not necessarily implemented in a server. The system according to the present disclosure may be implemented as a general information processing system. The present disclosure may be implemented as, for example, a software program that runs on a personal computer, or an application that runs on a smartphone or the like. The method according to the present disclosure may be provided to a user in a SaaS (Software as a Service) format.

In the above embodiment, an example form in which the specific processing is performed by one computer 22 has been described, but the technology of the present disclosure is not limited to this, and distributed processing for the specific processing may be performed by a plurality of computers including the computer 22. For example, the data generation model 58 may be provided in an external device of the data processing apparatus 12, and the external device may generate data according to the input data.

In the above embodiment, an example form in which the specific processing program 56 is stored in the storage 32 has been described, but the technology of the present disclosure is not limited to this. For example, the specific processing program 56 may be stored in a portable computer-readable non-transitory storage medium such as a USB (Universal Serial Bus) memory. The specific processing program 56 stored in the non-transitory storage medium is installed in the computer 22 of the data processing apparatus 12. The processor 28 executes the specific processing according to the specific processing program 56.

Also, the specific processing program 56 may be stored in a storage device such as a server connected to the data processing apparatus 12 via the network 54, and the specific processing program 56 may be downloaded in response to a request from the data processing apparatus 12 and installed in the computer 22.

Note that it is not necessary to store all of the specific processing program 56 in a storage device such as a server connected to the data processing apparatus 12 via the network 54, or to store all of the specific processing program 56 in the storage 32, and a part of the specific processing program 56 may be stored.

As hardware resources for executing the specific processing, various processors shown below can be used. Examples of the processor include a CPU, which is a general-purpose processor that functions as a hardware resource for executing the specific processing by executing software, that is, a program. Also, examples of the processor include a dedicated electric circuit, which is a processor having a circuit configuration specifically designed to execute specific processing, such as an FPGA (Field-Programmable Gate Array), a PLD (Programmable Logic Device), or an ASIC (Application Specific Integrated Circuit). A memory is built in or connected to any of the processors, and any of the processors executes the specific processing by using the memory.

The hardware resource that executes the specific processing may be configured by one of these various processors, or may be configured by a combination of two or more processors of the same type or different types (for example, a combination of a plurality of FPGAs, or a combination of a CPU and an FPGA). Also, the hardware resource that executes the specific processing may be one processor.

As an example of a configuration with one processor, first, there is a form in which one processor is configured by a combination of one or more CPUs and software, and this processor functions as a hardware resource for executing the specific processing. Second, there is a form in which a processor that realizes the functions of an entire system including a plurality of hardware resources for executing the specific processing with one IC chip, as represented by an SoC (System-on-a-chip) or the like, is used. In this way, the specific processing is realized using one or more of the various processors described above as hardware resources.

Furthermore, as a hardware structure of these various processors, more specifically, an electric circuit in which circuit elements such as semiconductor elements are combined can be used. Also, the specific processing described above is merely an example. Therefore, it goes without saying that unnecessary steps may be deleted, new steps may be added, or the processing order may be changed within a scope that does not depart from the gist.

The description and illustrations shown above are detailed descriptions of the parts related to the technology of the present disclosure, and are merely an example of the technology of the present disclosure. For example, the description regarding the above-described configuration, function, operation, and effect is a description regarding an example of the configuration, function, operation, and effect of the part related to the technology of the present disclosure. Therefore, it goes without saying that unnecessary parts may be deleted, new elements may be added, or replacements may be made to the description and illustrations shown above within a scope that does not depart from the gist of the technology of the present disclosure. Also, in order to avoid confusion and facilitate understanding of the parts related to the technology of the present disclosure, in the description and illustrations shown above, descriptions regarding common general technical knowledge and the like that do not require particular explanation for enabling the implementation of the technology of the present disclosure are omitted.

All documents, patent applications, and technical standards described in this specification are incorporated herein by reference to the same extent as if each individual document, patent application, and technical standard were specifically and individually indicated to be incorporated by reference.

Regarding the above embodiments, the following is further disclosed.

### Application Example 1

A system comprising a speech recognition unit, a natural language processing unit, a machine learning unit, a summary generation unit, and a video clip generation unit. The speech recognition unit extracts audio data from a video of a care meeting held in a nursing care facility, and performs noise removal and speaker separation to realize high-precision text conversion. The natural language processing unit performs morphological analysis, syntactic analysis, and semantic analysis on the text data to extract important keywords and phrases. The machine learning unit learns past care meeting data and identifies topics and key points of discussion of the meeting based on the extracted information. The summary generation unit generates a summary based on the identified key points and provides it in a format that care staff can quickly understand. The video clip generation unit clips important parts of the video clip so that a user can directly watch them.

The system, wherein the speech recognition unit includes a function of accurately recognizing individual utterances even when there are multiple speakers, by removing environmental sounds in the facility. The speech recognition unit is trained using an extensive audio dataset to accurately recognize the speech of speakers with different accents and dialects. Furthermore, the speech recognition unit enables real-time speech recognition and can perform text conversion instantly during a meeting.

The system, wherein the summary generation unit provides a generated summary in a text file or PDF format, and provides it in a format that care staff can easily access. The summary generation unit is provided with a function to adjust the level of detail of the summary according to the user's needs, and can provide information in various formats, from a short summary to a detailed report. Furthermore, the summary generation unit also supports summary generation in different languages, and supports use in international teams.

An information processing system comprising: a circuit configured to: extract audio data from a video of a meeting; convert the audio data into text data; perform morphological analysis, syntactic analysis, and semantic analysis on the text data to extract keywords from the text data; identify key points of the meeting using the extracted keywords as input via a machine learning model trained on past meeting data; generate a summary of the meeting based on the identified key points; and output the summary.

The system, wherein the circuit is configured to: perform preprocessing including noise removal and speaker separation on the audio data.

The system, wherein the circuit is configured to: analyze appearance patterns of frequently occurring keywords and specific phrases to extract information with a relevance score above a predetermined threshold; and condense the extracted information to generate the summary.

The system, wherein the circuit is configured to: output the generated summary as a text file.

The system, wherein the circuit is configured to: clip a video segment corresponding to the identified key points from the video of the meeting and output the video segment.

An information processing system method: extracting audio data from a video of a meeting; converting the audio data into text data; performing morphological analysis, syntactic analysis, and semantic analysis on the text data to extract keywords from the text data; identifying key points of the meeting using the extracted keywords as input via a machine learning model trained on past meeting data; generating a summary of the meeting based on the identified key points; and outputting the summary.

1. An information processing system comprising:
a circuit configured to:
extract audio data from a video of a meeting;
convert the audio data into text data;
perform morphological analysis, syntactic analysis, and semantic analysis on the text data to extract keywords from the text data;
identify key points of the meeting using the extracted keywords as input via a machine learning model trained on past meeting data;
generate a summary of the meeting based on the identified key points; and
output the summary.

2. The system according to claim 1,
wherein the circuit is configured to:
perform preprocessing including noise removal and speaker separation on the audio data.

3. The system according to claim 1,
wherein the circuit is configured to:
analyze appearance patterns of frequently occurring keywords and specific phrases to extract information with a relevance score above a predetermined threshold; and
condense the extracted information to generate the summary.

4. The system according to claim 1,
wherein the circuit is configured to:
output the generated summary as a text file.

5. The system according to claim 1,
wherein the circuit is configured to:
clip a video segment corresponding to the identified key points from the video of the meeting and output the video segment.

6. An information processing system method:
extracting audio data from a video of a meeting;
converting the audio data into text data;
performing morphological analysis, syntactic analysis, and semantic analysis on the text data to extract keywords from the text data;
identifying key points of the meeting using the extracted keywords as input via a machine learning model trained on past meeting data;
generating a summary of the meeting based on the identified key points; and
outputting the summary.
